(19) United States
(12) Patent Application Publication
(10) Pub. No.: US 2010/0319503 A1
(43) Pub. Date: Dec. 23, 2010

(54) DEVICE AND METHOD FOR THE PERFORATION OF DUCTILE AND/OR TACKY AND/OR ELASTIC SHEET MATERIAL

(75) Inventors: Jan Bakker, Bleskensgraaf (NL); Abraham Jan Verschoor, Wijngaarden (NL); Simon Den Hartigh, Oud Alblas (NL)

Correspondence Address: YOUNG & THOMPSON, 209 Madison Street, Suite 500, Alexandria, VA, 22314, US

(73) Assignee: EUROTRON B.V., Bleskensgraaf (NL)

(21) Appl. No.: 12/795,130

(22) Filed: Jun. 7, 2010

(30) Foreign Application Priority Data
Apr. 14, 2008 (NL) 2001481
Apr. 14, 2009 (EP) 09157887.2

(51) Int. Cl. B26F 1/02; B26D 7/01; B26F 1/14

(52) U.S. Cl. 83/13; 83/100; 83/685

(57) ABSTRACT

A device for the perforation of a ductile and/or tacky sheet material includes a frame, pressing tool, a stamp provided with at least one hole, as well as a drive element suspended in the frame for causing the pressing tool and the stamp to move toward each other and away from each other respectively. The pressing tool is provided with an end face and the stamp with a die-edge surrounding the die-hole, which can be caused to act cooperatively with the end face of the pressing tool. The lateral dimensions of the end face are greater than the lateral dimensions of the die-edge, whilst the end face comes into contact with the die-edge essentially around the entire periphery thereof, or the end face and the die-edge enclose a gap with a fixed lateral dimension essentially around the entire periphery thereof.

The invention relates to the provision of holes in sheet materials. Normally, a punching machine is used to perform this operation, by means of which the holes are punched into the material. Such a punching machine comprises a pin-shaped punch of the desired cross section, and a stamp with a corresponding hole into which the punch can be tightly received. By pressing the punch into the hole in the stamp, the sheet material is subjected to such a shear load that a portion of the material of the same shape as the punch and the hole is removed from the sheet material.

Such an operation may be applied for many different kinds of sheet material, such as metallic plates, plastic plates and the like. Plastic materials have a lower hardness than metals so that during punching more severe deformation may occur, but nonetheless, the punching process may also be applied, mostly with success, for such plastics.

The shearing that occurs due to the interaction between the punch and the edge of the hole in the stamp is sometimes evidently insufficient to achieve full separation between the portion to be removed and the rest of the sheet material. In particular, it is evident that for such materials, the portion to be removed still remains attached to the rest of the sheet material. This is caused by the phenomenon whereby threads, slithers and other such shapes end up between the punch and the wall of the punching hole and can no longer be easily separated therefrom.

U.S. Pat. No. 1,726,219 describes a device comprising a frame, a pressing tool with an end face, a stamp with at least one die-hole and a die-edge surrounding the die-hole, as well as a drive mechanism mounted in the frame for moving the pressing tool and the stamp towards each other or away from each other respectively, wherein the lateral dimensions of the end face are larger than the lateral dimensions of the die-edge and the end face and the die-edge can be caused to interact in such a manner that the end face essentially strikes the die-edge over the entire circumference thereof, or that the end face and the die-edge essentially enclose a gap of constant lateral dimension over the entire circumference thereof.

In this known device a pressing tool is applied, the lateral dimensions of which are larger than those of the corresponding die-hole in the stamp. The pressing tool can therefore not penetrate into the die-hole. The effect of this is that when perforating a sheet material, the type of shearing mentioned in the foregoing does not occur. Instead of such, the material becomes very highly compressed locally, i.e. in the region where the end face of the pressing tool and the die-edge approach each other. Therefore, forces primarily occur in the material that are directed laterally, or even perpendicular, to said end face of the pressing tool. This very high compression of the material, which is also necessarily more or less perpendicular to the surface of the sheet material, ultimately leads to the separation of the portion to be removed from the rest of the sheet material.

The known device can be used to perforate a rubber plate. For relatively soft materials, or materials of a relatively high plasticity and tackiness, the device as described in the foregoing can, however, pose problems. An example of such a material is ethylene vinyl acetate (EVA), which is ductile and tacky. In practice, the provision of holes in this material by means of pressing has proven to be quite difficult. Conversely, it is also not that easy to provide the holes by means of a drilling process, also due to the ductile and tacky character of the material. An additional drawback is that a material such as EVA is difficult to handle. It is particularly unstable with regard to its shape and dimensional characteristics, in that a sheet of such a material easily becomes plastically deformed during the handling thereof. Even just laying such a sheet into the device for the provision of holes and then removing it again causes great problems. During removal, it is very difficult to lift the sheet provided with holes in such a manner that the desired shape and dimensional characteristics are retained. There is a great risk that the deformation resulting from lifting is so large that the sheet has to be rejected. Then there is also much wastage, which delays production and increases costs.

The object of the invention, therefore, is to provide a device of the type described in the foregoing that is also suitable for the aforementioned delicate sheets made from materials such as EVA. This is achieved by the use of a vacuum table comprising a holding surface provided with vacuum openings so that the sheet material is held against said holding surface of the vacuum table by means of a vacuum, which vacuum table can be positioned in respect of the frame in such a manner that its holding surface is turned towards the stamp and wherein the vacuum table is provided with an insertion opening through which the pressing tool extends or can be inserted. A “vacuum” in this case refers to an underpressure which, when exerted, causes the sheet material to remain adhered to the vacuum table.

In the device according to the invention, the sheet material, such as EVA, can firstly be laid down upon the vacuum table. Subsequently, this material is fixed in that position by the effect of the vacuum generated in the vacuum table. The process using the pressing tool can then be performed on the fixed material without problems occurring, wherein it is ensured that, in spite of the resulting forces that occur in the process, the sheet retains its original shape and position. After processing, the sheet remains stabilized under the influence of the vacuum or the underpressure and it can then be transported along with the vacuum table to the following processing station.

The stabilisation of the sheet material can be even further improved if the stamp is incorporated in a workbench against which the vacuum table, including the sheet material, can be positioned. In that case the sheet material can be clamped between the vacuum table and the workbench. The stability of the sheet is thus further improved.

The vacuum table may comprise a chamber that is demarcated on one side by a plate in which the vacuum openings are provided. This chamber is connected to a vacuum source, for example, by means of a flexible tube. The vacuum effect can thereby be maintained whenever the vacuum table is manipulated and moved against the workbench in the device, and is subsequently removed from the workbench along with the perforated sheet. The approach of the end face of the pressing tool and the die-edge of the stamp can be continued until these ultimately come into contact with one another. In this position, at least full separation or severance is achieved.

The shape of the end face and the corresponding die-edge can be selected in such a manner that the desired shape of the removed portion is achieved, corresponding to the desired shape of the hole provided in the sheet material. In particular, a circular die-edge can be provided. In that case, the end face can be cone-shaped, at least in the region thereof which is caused to interact with the die-edge. In particular, the end face may be in the shape of a truncated cone. However it is also possible to opt for other cross-sectional shapes, such as oval or elliptical and the like, to match a correspondingly shaped stamp.

The separated portions have to be removed from the die-hole; to which end the die-hole may be formed as a through-hole for the disposal of the portions at the end of the die-hole facing away from its die-edge. In particular, the die-hole may transform at the end facing away from its die-edge to a space with greater lateral dimensions for the disposal of the portions perforated from the sheet material.

The pressing tool can be movable back and forth in respect of the vacuum table. To this end it is received in an opening in the vacuum table that is isolated from the vacuum that can be generated in the vacuum table. The pressing tool can be suspended on the vacuum table if required.

The invention relates further to a method for the perforation of a ductile and/or tacky sheet material, such as ethylene vinyl acetate (EVA), by means of the device described in the foregoing, comprising the steps of:
causing the sheet material to adhere to the holding surface of the vacuum table by the effect of an underpressure,
positioning the vacuum table along with the sheet material attached thereto against the stamp,
moving the stamp and the pressing tool towards each other,
compressing and/or tightly holding the sheet material between the die-edge of the stamp and the end face of the pressing tool,
severing the sheet material as a result of the compression and/or tightly holding it in a direction essentially perpendicular to the end face of the pressing tool.

As previously referred to, the vacuum has a stabilizing effect on the sheet material, thus improving the result of the process. The speed of the process can be improved further, whilst maintaining the quality of the process, by moving the vacuum table and the stamp towards each other whilst simultaneously moving the pressing tool and the stamp towards each other.

The foregoing refers to a pressing tool that is caused to act cooperatively with a stamp. It goes without saying that the device may also comprise several such pressing tools, each with its own corresponding stamp. The pressing tools can all be inserted through a respective opening in the vacuum table, whilst the stamps can all be incorporated within the workbench.

As previously mentioned in the foregoing, depending on the nature of the material being processed, it may be necessary to cause the die-edge and the end face to strike against each other. In order to avoid resulting wear, an additional provision can be made so that the relative motions of the pressing tool and the stamp are controlled in such a manner that the contact between them is only very light, such that there is no or only minimal occurrence of wear. However, it may also be possible to fix the stamp and the pressing tool in respect of each other, in a position wherein the die-edge and the end face fall just short of coming into contact with each other. If, in such a state, a complete separation between the portion to be removed and the rest of the sheet material has occurred, then no contact is required between the die-edge and the end face, so that, as a result, no wear occurs.

As previously mentioned in the foregoing, the method and the device according to the invention are particularly well suited for processing ductile and flexible materials. Such materials may be exposed to all kinds of deformation during processing using the device according to the invention. In particular, the portion to be separated is thereby exposed to the pressing force exerted thereon by the end face. If such an end face has a somewhat convex shape, as is the case with a cone-shaped or truncated cone-shaped end face, the portion to be separated becomes tensioned and stretched across the convex form. This stretched state is retained until the portion concerned actually becomes separated from the rest of the sheet material. The resulting effect thereof is that the separated portion retains a larger size than that of the die-hole, in spite of the release of the tension, which causes it to shrink somewhat. The effect of this is that, due to friction against the wall of the die-hole, the separated portion remains firmly in place, and is only pushed further into the die-hole by the following portions to be separated. This ensures the controlled release and disposal of the separated portions from the die-hole.

The process according to the invention relates further to the supply of compressed air to the vacuum chamber, after compression and/or tightly holding the sheet material, in order to release the sheet material from the vacuum table.

The invention will be described in more detail with reference to an exemplary embodiment of the device as shown schematically in the accompanying figures.

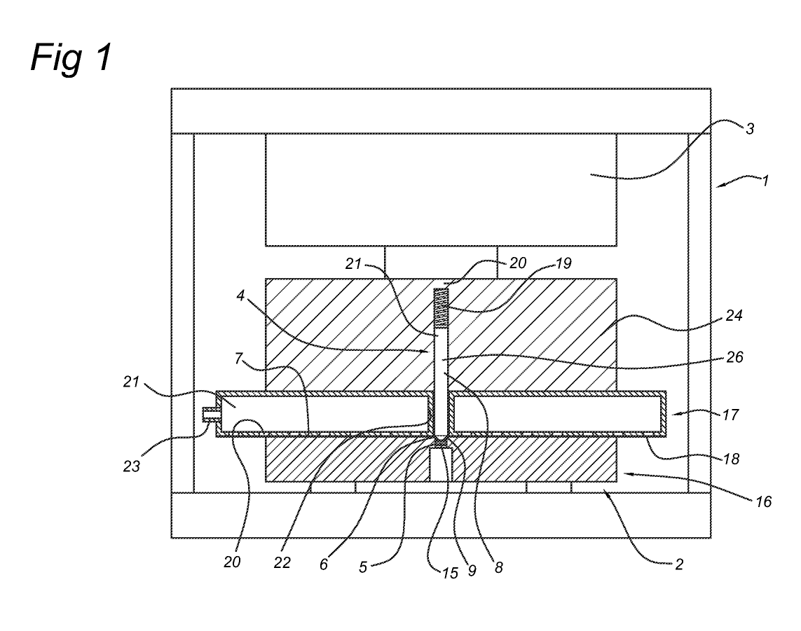

FIG. 1 shows a side view of the device according to the invention.

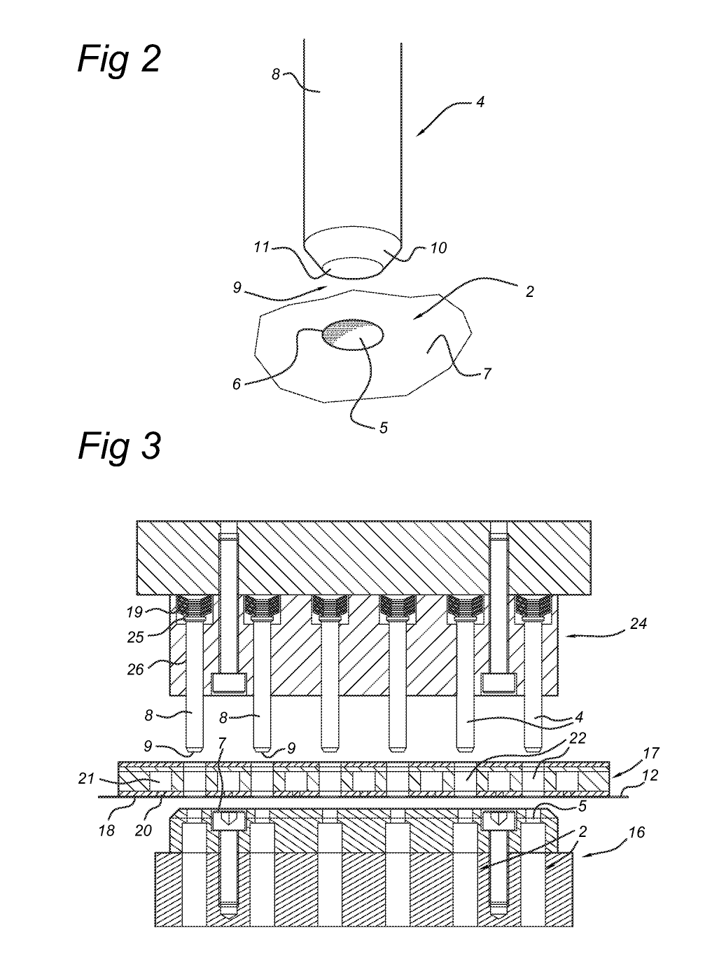

FIG. 2 shows a perspective view of a part of the pin-shaped pressing tool and of the stamp.

FIG. 3 shows an exploded side view.

The device according to the invention, as shown in FIG. 1, comprises a frame 1, wherein the stamp 2 is fixed into the workbench 16. Further to this, drive means 3 are attached to the frame, on which the block 24 and the pressing tool 3 is suspended. The stamp 2 comprises a die-hole 5 which defines a die-edge 6 on the upper surface 7 of the stamp 2.

The pressing tool 5 comprises the pin 8, on the end of which an end face 9 is disposed. This end face 9 is of a truncated conical shape comprising the conical end-face portion 10 and the flat end-face portion 11. The diameter of the pin 8 is greater than the diameter of the die-hole 5. Consequently, when the pressing tool 4 is moved towards the stamp 2, the conical end-face portion 10 comes to rest opposite, or in contact with the die-edge 6 as shown in FIG. 1. At the position of the die-edge 6 there remains either a very to narrow gap or no gap at all. The pin 8 is incorporated in the hole 26 in the block 24.

The pin 8 is acted upon by the spring 19, such that a predefined pressing force is exerted dependent on the spring force applied. If, as is discussed in further detail hereinafter, multiple pins 8 are used, these may all function with the same pressing force due to the action of their respective corresponding spring 19.

The sheet material 12 is laid upon the upper surface 7 of the pressing table 16 and the stamp 2. To this end, the sheet material 12 is first held onto the lower surface 18 of the vacuum table 17. The vacuum table comprises a vacuum chamber 21 that can be connected to a source of underpressure by means of the vacuum connection 23. The vacuum chamber comprises a number of vacuum openings 20 on the underside, by means of which the sheet material can be drawn onto and held against the underside of the vacuum table 17. In this state, the vacuum table with the sheet material adhered thereto is placed onto the workbench 16. The sheet material is therefore clamped between said vacuum table 17 and the workbench 16, in particular between the lower surface 18 and the upper surface 7 respectively.

An opening 22 runs through the vacuum table 17, isolated from the vacuum chamber 21, through which the pin 8 of the pressing element 2 is inserted. When the pressing element 4 is moved towards the stamp 2, the material becomes highly compressed in the region where the conical end-face portion 10 approaches the die-edge 6. This causes a circular disc 15 to become detached from the rest of the sheet material 12. Due to the action of friction, this circular disc 15 initially remains firmly in place within the die-hole 5, in particular against the wall 13 thereof. When several perforations are provided, multiple circular discs 15 collect within the die-hole 5. These circular discs 15 eventually collect within the broader section 14, after which they can be removed.

In the embodiment shown in FIG. 3, several pins 8 are incorporated in the block 24, each compressed by a spring 19 comprising a stack of cup springs. The pins 8 each comprise a stop 25 that prevents them falling out of the holes 26. Several stamps 2 are correspondingly incorporated in the workbench 16. The vacuum plate is provided with corresponding insertion openings 22, through each of which a pin 8 can be inserted.

Although in the foregoing a pin is described with reference to a pressing tool, the invention is not limited to such. Alternatively, the pressing tool may also be constructed to in the form of a hollow tube, in which case the outer wall forms the end face that act cooperatively with the stamp. The cross section of the pressing tool and the stamp may have various desired forms, such as circular, oval, etc.

### LIST OF REFERENCES

1. Frame
2. Stamp
3. Drive means
4. Pressing tool
5. Die-hole
6. Die-edge
7. Upper surface of stamp/workbench
8. Shaft of pressing tool
9. End face of pressing tool
10. Conical end-face portion of pressing tool
11. Flat end-face portion of pressing tool
12. Sheet material
13. Wall of die-hole
14. Broader section of stamp
15. Disc
16. Workbench
17. Vacuum table
18. Lower surface of vacuum table
19. Spring
20. Vacuum opening
21. Chamber
22. Insertion opening
23. Vacuum connection
24. Block
25. Stop
26. Hole in block

1. Device for the perforation of ductile and/or tacky sheets of material, comprising a frame (1), at least one pressing tool (4) with an end face (9), a stamp (2) with at least one die-hole (5) and a die-edge (6) surrounding the die-hole, as well as drive means (3) suspended in the frame (1) for moving the pressing tool (4) and the stamp (2) towards each other and away from each other respectively, wherein the lateral dimensions of the end face (9) are greater than the lateral dimensions of the die-hole (5) and the end face (9) and the die-edge (6) can be caused to act cooperatively with each other, so that the end face (9) comes into contact with the die-edge (6) essentially around the entire perimeter thereof, or the end face and the die-edge include a gap of constant transverse dimension essentially around the entire perimeter thereof, characterized in that a vacuum table (17) with a holding surface (18) provided with vacuum openings for holding the sheet material (12) against the holding surface (18) of the vacuum table by means of a vacuum, which vacuum table can be positioned in relation to the frame (1) such that the holding surface (18) thereof faces towards the stamp (2) and wherein the vacuum table (17) is provided with an insertion opening (22) through which the pressing tool (4) extends or can be inserted.

2. Device according to claim 1, wherein the stamp (2) is located in a workbench (16) against which the vacuum table (17) can be placed, thus enclosing the sheet material (12).

3. Device according to claim 2, wherein the sheet material (12) can be clamped between the vacuum table (17) and the workbench (16).

4. Device according to claim 1, wherein the vacuum table (17) comprises a chamber (21) bounded on one side by a plate or surface (18) wherein the vacuum openings (20) are provided.

5. Device according to claim 1, wherein the die-edge (6) is circular and the end face (9) is conical (10), at least in the region thereof that can be caused to act cooperatively with the die-edge (6).

6. Device according to claim 5, wherein the die-hole (5) transforms at the end facing away from that of the die-edge (6) into a space (14) of greater lateral dimensions for the disposal of the portions (15) perforated from the sheet material (12).

7. Device according to claim 1, wherein the stamp (2) is permanently mounted in the frame (1).

8. Device according to claim 1, wherein the pressing tool (4) is compressed by the pressure of a pre-tensioned spring (19).

9. Device according to claim 1, wherein the pressing tool (4) can be moved back and forth through the opening (22) in the vacuum table.

10. Device according to claim 1, wherein the pressing tool is suspended in the insertion opening in the vacuum table.

11. Device according to claim 1, wherein the insertion opening (22) is isolated in respect of the vacuum in the vacuum chamber (21).

12. Method for the perforation of a ductile and/or tacky and/or elastic sheet material, such as ethylene vinyl acetate (EVA), by means of the device according to claim 1, comprising the steps of:
causing the sheet material to adhere to the holding surface (18) of the vacuum table (17) under the influence of an underpressure,
positioning the vacuum table along with the sheet material (12) attached thereto against the stamp (2),
moving the stamp (2) and the pressing tool (4) towards each other,
compressing and/or tightly holding the sheet material (12) between the die-edge (6) of the stamp (2) and the end face (9) of the pressing tool (4),
cutting through the sheet material (12) as a result of the compression and/or a tight holding action in a direction essentially perpendicular to the end face (9) of the pressing tool (4).

13. Method according to claim 12, comprising the retention, under the effect of underpressure, of the adhesion of the sheet material on the holding surface of the vacuum table whilst compressing and/or tightly holding the sheet material between the die-edge of the stamp and the end face of the pressing tool.

14. Method according to claim 12, comprising the supply of compressed air to the vacuum chamber (21) after compression and/or tightly holding the sheet material in order to release the sheet material from the vacuum table (17).

15. Method according to claim 12, comprising the movement of the vacuum table (17) and the stamp (2) towards each other, whilst simultaneously moving the pressing tool (4) and the stamp (2) towards each other.

16. Device according to claim 2, wherein the vacuum table (17) comprises a chamber (21) bounded on one side by a plate or surface (18) wherein the vacuum openings (20) are provided.

17. Device according to claim 3, wherein the vacuum table (17) comprises a chamber (21) bounded on one side by a plate or surface (18) wherein the vacuum openings (20) are provided.

18. Device according to claim 2, wherein the die-edge (6) is circular and the end face (9) is conical (10), at least in the region thereof that can be caused to act cooperatively with the die-edge (6).

19. Device according to claim 3, wherein the die-edge (6) is circular and the end face (9) is conical (10), at least in the region thereof that can be caused to act cooperatively with the die-edge (6).

20. Device according to claim 4, wherein the die-edge (6) is circular and the end face (9) is conical (10), at least in the region thereof that can be caused to act cooperatively with the die-edge (6).
